(19) United States
(12) Patent Application Publication
(10) Pub. No.: US 2013/0055641 A1
(43) Pub. Date: Mar. 7, 2013

(54) Electrical Garage Door With Secondary Power Supply

(71) Applicant: Shih Fang Chen, Taoyuan County (TW)

(72) Inventor: Shih Fang Chen, Taoyuan County (TW)

(73) Assignee: INNO DIGIC LIMITED, Taoyuan County (TW)

(21) Appl. No.: 13/227,375

(22) Filed: Sep. 7, 2011

(51) Int. Cl. E06B 5/00; E05F 15/18

(52) U.S. Cl. 49/199

(57) ABSTRACT

The present invention relates to an electrical garage door with a secondary power supply, comprising: a garage door mechanism, a driving mechanism, a power receiving device, and a controlling and boosting device. In the present invention, it mainly installs the power receiving device and the controlling and boosting device to the garage door mechanism; therefore, once the city power discontinues to supply power to the controlling device and the driving mechanism of the garage door mechanism, user may connect a car cigarette lighter power cable to the power receiving device and provide a secondary power to the power receiving device, and then the controlling and boosting device can convert the voltage value of the secondary power to a target voltage value, and then the controlling and boosting device outputs the secondary power with the target voltage value for driving the driving mechanism to operate.

### BACKGROUND OF THE INVENTION

1. Technical Field

The present invention relates to a garage door, and more particularly, to an electrical garage door with a secondary power supply capable of receiving a second power supplied by an external power.

2. Description of Related Art

Based on the convenience requirement, a garage door is disposed and located at the car entrance in many community buildings. When the resident of the community building drives a car to the car entrance, the resident may control the garage door to up for opening the car entrance by using a remoter, and then, the resident controls the garage door to down for closing the car entrance after the car is driven and passes through the car entrance.

Please refer to FIG. 1, which illustrates a stereo diagram of a conventional garage door system. As shown in FIG. 1, the conventional garage door system 1 includes: a garage door 11′ and a driving mechanism 13′. Wherein the driving mechanism 13′ is electrically connected to city electricity through an electrical cable 14′. The garage door 11′ consists of door sheets and is connected to the driving mechanism 13′, such that the garage door 11′ can be driven to up or down by the driving mechanism 13′. As shown in FIG. 1, when a driver drives a car 2′ to the front of the garage door 11′, the driver can use a remoter to output a control signal for controlling the driving mechanism 13′ to operate and drive the garage door 11′ to up.

The aforesaid garage door system 1′ is widely installed in the car entrance of the community building, however, since the garage door system 1′ not includes a backup power supply, so that, once the city electricity is broken off, the garage door 11′ of the garage door system 1′ can not be controlled to up or down due to the city electricity discontinues to supply power, then, the residents' cars would be blocked by the garage door 11′ and can not pass through the car entrance of the community building, that causes a great trouble for the residents.

Accordingly, in view of the conventional garage door system still has shortcomings and drawbacks, the inventor of the present application has made great efforts to make inventive research thereon and eventually provided an electrical garage door with a secondary power supply.

### BRIEF SUMMARY OF THE INVENTION

The primary objective of the present invention is to provide an electrical garage door with a secondary power supply, in which, it mainly installs a power receiving device and a controlling and boosting device to a garage door mechanism, therefore, once the city power discontinues to supply power to the driving mechanism of the garage door mechanism, user may connect a car cigarette lighter power cable to the power receiving device and provide a secondary power to the power receiving device, so that, the controlling and boosting device can boost the voltage value of the secondary power to a target voltage value for controlling the driving mechanism to operate, such that a garage door of the garage door mechanism may be driven to up or down.

Thus, in order to achieve the primary objective of the present invention, the inventor proposes an electrical garage door with a secondary power supply, comprising:

a garage door mechanism, which comprises: a main frame, comprising a plurality of supporting pillar and having a entrance; and a garage door, disposed on the main frame and located at the entrance for closing the entrance;

a driving mechanism, disposed on the main frame and connected to the garage door mechanism, the driving mechanism also electrically connects to a first power source, such that the first power source may provide a first power to the driving mechanism, and then the driving mechanism may operate and drive the garage door to up or down;

a power receiving device, which is able to be electrically connected with an external second power source for receiving a second power provided by the external second power source;

a controlling and boosting device, connected to the driving mechanism and comprising: a voltage-regulating unit, coupled to the power receiving device for receiving the second power; a controlling unit, coupled to the voltage-regulating unit for controlling the output of the second power; and a voltage-boosting unit, coupled to the controlling unit for boosting the voltage value of the second power to a target voltage value;

wherein when the first power source discontinues to supply the first power, the driving mechanism can not continue to operate for driving the garage door to up or down;

wherein after the first power source discontinues to supply the first power, the power receiving device can be electrically connected with the second power source at that time, so that the power receiving device would receive the second power provided by the second power source, and then controlling and boosting device would convert the voltage value of the second power to the target voltage and output the second power for controlling the driving mechanism to operate and drive the garage door to up or down.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a stereo diagram of a conventional garage door system;

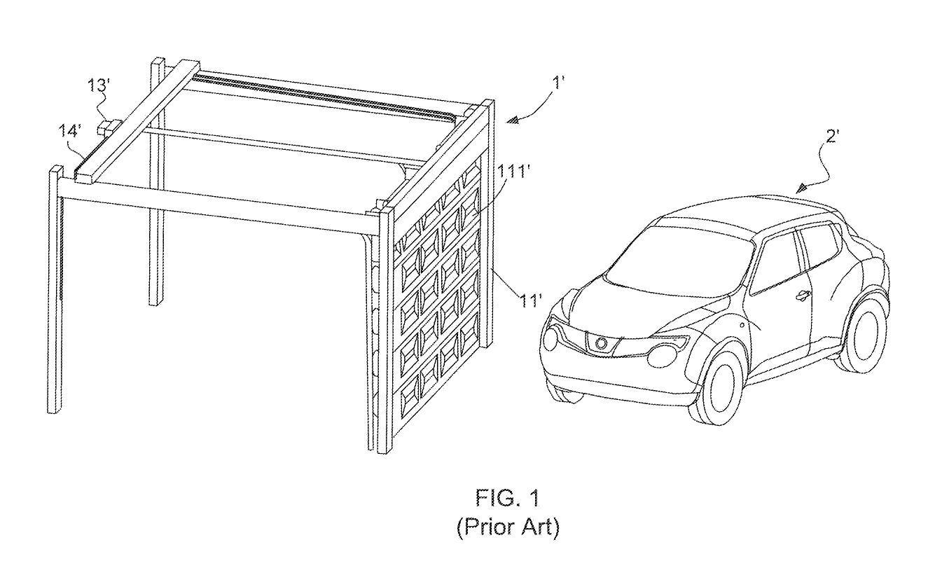

FIG. 2 is a stereo view of an electrical garage door with a secondary power supply according to the present invention;

FIG. 3 is a block diagram of the electrical garage door with the secondary power supply according to the present invention; and

FIG. 4 is the stereo view of a controlling and boosting device and a power receiving device of the electrical garage door with the secondary power supply according to the present invention.

### DETAILED DESCRIPTION OF THE INVENTION

To more clearly describe an electrical garage door with a secondary power supply according to the present invention, embodiments of the present invention will be described in detail with reference to the attached drawings hereinafter.

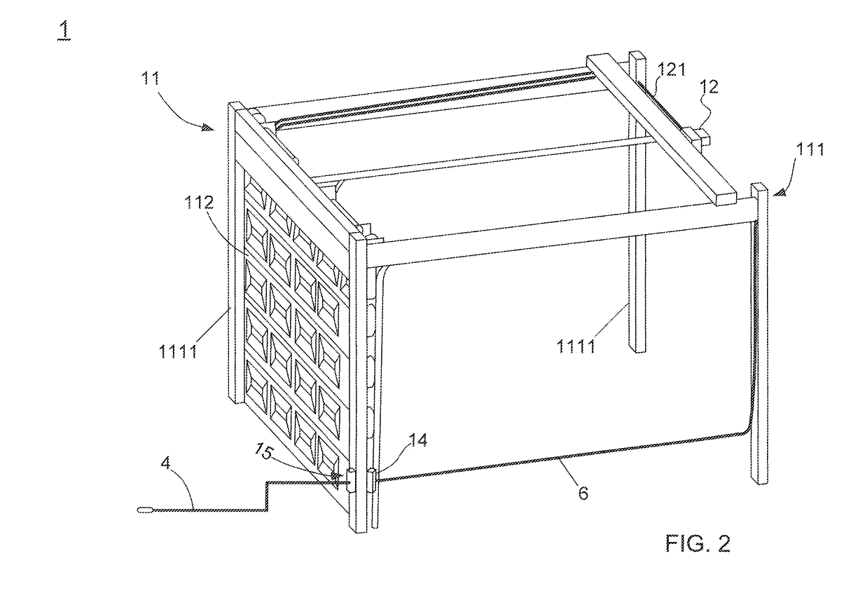

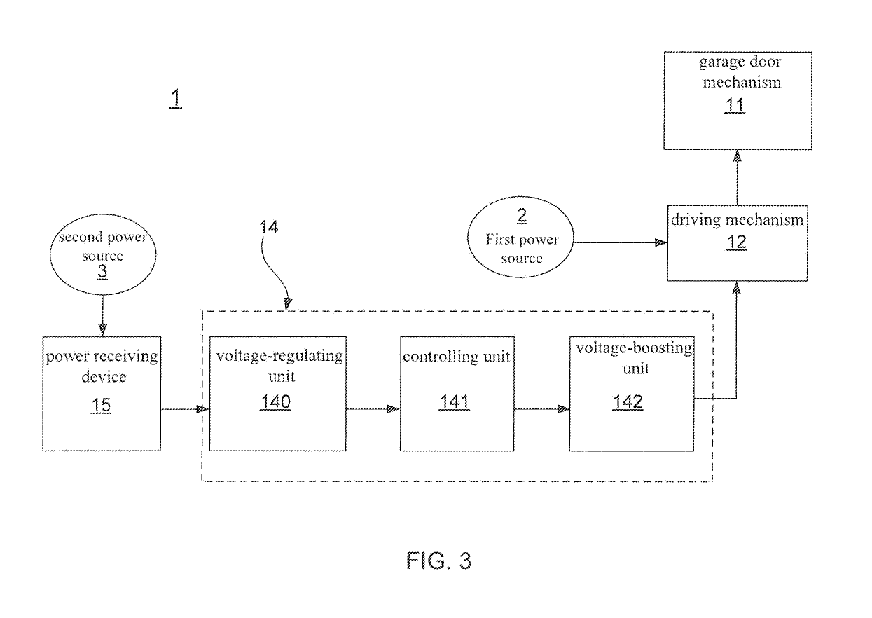

Please refer to FIG. 2 and FIG. 3, which respectively illustrates a stereo view and a block diagram of the electrical garage door with a secondary power supply according to the present invention. As shown in FIG. 2 and FIG. 3, the electrical garage door 1 with a secondary power supply includes: a garage door mechanism 11, a driving mechanism 12, a controlling and boosting device 14, and a power receiving device 15.

The garage door mechanism 11 includes a main frame 111 and a garage door 112, wherein the main frame 111 consists of a plurality of supporting pillars 1111 and has an entrance, and the garage door 112 is disposed on the main frame 111 and located at the entrance for closing the entrance. The driving mechanism 12 is disposed on the main frame 111 and connected to the garage door mechanism 11. Besides, the driving mechanism 12 also electrically connected to a first power source 2, such that the first power source may provide a first power to the driving mechanism 12, and then the driving mechanism 12 is able to operate and drive the garage door 112 to up or down.

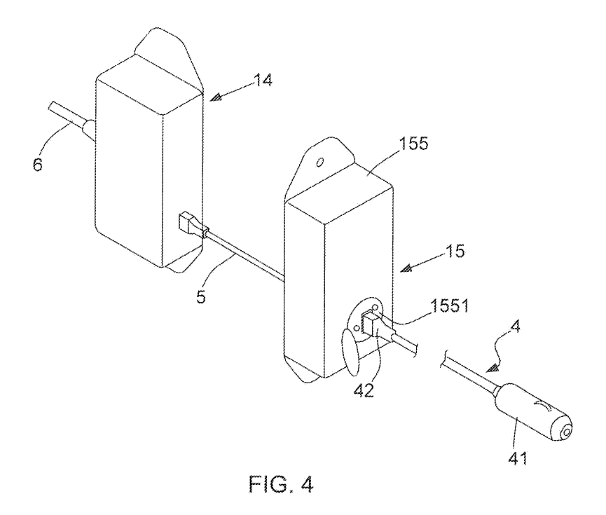

Please continuously refer to FIG. 2 and FIG. 3, and simultaneously referring to FIG. 4, which illustrates the stereo view of the controlling and boosting device and the power receiving device of the electrical garage door with the secondary power supply. As shown in FIGs., the power receiving device 15 is capable of being electrically connected to an external second power source 3 for receiving a second power provided by the external second power source 3, in addition, the power receiving device 15 includes a water-proof housing 155 provided with a cigarette lighter socket 1551 thereon.

In the framework of the electrical garage door 1 with the secondary power supply of the present invention, the second power source 3 is automobile electricity outputted from a car cigarette lighter socket, so that, a cigarette lighter power cable 4 having a cigarette lighter plug 41 and a power plug 42 can be used to connect a cigarette lighter socket in a car and the cigarette lighter socket 1551 on the water-proof housing 155, respectively; therefore, the second power source 3 is electrically connected to the power receiving device 15 and outputs the second power to the power receiving device 15. The controlling and boosting device 14 is connected to the driving mechanism 12 and has a voltage-regulating unit 140, a controlling unit 141 and a voltage-boosting unit 142, wherein the voltage-regulating unit 140 is coupled to the power receiving device 15 for receiving the second power. The controlling unit 141 is coupled to the voltage-regulating unit 140 for controlling the output of the second power, and the voltage-boosting unit 142 is coupled to the controlling unit 141 for boosting the voltage value of the second power to a target voltage value. Herein, what must to be particularly introduced is that, since the voltage value of auxiliary power (i.e., the second power) supplied by the automobile electricity is ranged from 12V to 24V, so that, in the electrical garage door 1 with the secondary power supply of the present invention, the main function of the controlling and boosting device 14 is to convert the voltage value of the auxiliary power (i.e., the second power) to a target voltage value and controls the output of the auxiliary power with the target voltage value, ensuring auxiliary power with the target voltage value is sufficient to driving the driving mechanism 12 to operate.

Moreover, in the electrical garage door 1 with the secondary power supply of the present invention, when the first power source 2 continues to supply the first power to the driving mechanism 12, the user can send the first controlling signal for controlling the driving mechanism 12 to operate and drive the garage door 112 to up or down; However, once the first power source 2 discontinues to supply the first power, the driving mechanism 12 can not continue to operate for driving the garage door 112 to up or down; Meanwhile, the user may electrically connects the external second power source 3 (i.e., the automobile electricity) to the power receiving device 15, and sequentially, the controlling and boosting device 14 would convert the voltage value of the second power to the target value, such that the second power is adequate for driving the driving mechanism 12 to operate, at this time, the user can make the controlling and boosting device 14 output the second power with the target value to the driving mechanism 12 by way of using a remoter, and then the driving mechanism 12 starts to operate and drive the garage door 112 to up or down. To more clearly describe the electrical garage door 1 with the secondary power supply of the present invention, when the user uses the remoter for making the controlling and boosting device 14 output the second power with the target voltage value to the driving mechanism 12, the driving mechanism 12 is controlled to operation and drive the garage door 112 to up or down. Thus, the framework and functionality of the electrical garage door 1 with the secondary power supply of the present invention have been clearly introduced, moreover, what must be additionally described is that, in the electrical garage door 1 with the secondary power supply of the present invention, when the power receiving device 15 outputs the second power to the controlling and boosting device 14, a voltage transmission line 5 is used for transmitting the second power from the power receiving device 15 to the controlling device 14. Besides, when the controlling and boosting device 14 outputs the second power with the target voltage value to the driving mechanism 12, a transmission line 6 is used for transmitting the second power from the controlling and boosting device 14 to the driving mechanism 12.

Thus, through above descriptions, the exemplary framework and the functionality of the electrical garage door with the secondary power supply of the present invention have been clearly disclosed and introduced; So that, in summary, the present invention has the following advantages:

1. The electrical garage door with the secondary power supply of the present invention has two power supplies (i.e., the first power source 2 and the second power source 3), so that, when the first power source 2 discontinues to supply the first power, meanwhile, the user may electrically connects the second power source 3 to the power receiving device 15 for receiving the second power supplied by the second power source, and then the controlling and boosting device 14 sequentially converts the voltage value of the second power to a target voltage value, such that the second power with the target voltage value is adequate for driving the driving mechanism 12; at this time, the user can make the controlling and boosting device 14 output the second controlling signal to the driving mechanism 12 by using a remoter, and then the driving mechanism 12 starts to operate and drive the garage door 112 to up or down.

2. Inheriting to above point 1, moreover, since the controlling and boosting device 14 is capable of converting the voltage value of the second power to a target voltage value, it would be converted to the target voltage value from 12 V to 24 V of the second power supplied by the second power source 3 is, so that, the user can utilize any one automobile electricity outputted from a car cigarette lighter socket to start the operation of the driving mechanism.

The above description is made on embodiments of the present invention. However, the embodiments are not intended to limit scope of the present invention, and all equivalent implementations or alterations within the spirit of the present invention still fall within the scope of the present invention.

1. An electrical garage door with a secondary power supply, comprising:
a garage door mechanism, comprising:
a main frame, comprising a plurality of supporting pillar and having a entrance; and
a garage door, being disposed on the main frame and located at the entrance for closing the entrance;
a driving mechanism, being disposed on the main frame and connected to the garage door mechanism, the driving mechanism also electrically connecting to a first power source, such that the first power source may provide a first power to the driving mechanism, and then the driving mechanism operates and drives the garage door to up or down;
a power receiving device, being able to be electrically connected with an external second power source for receiving a second power provided by the external second power source;
a controlling and boosting device, being connected to the driving mechanism and comprising:
a voltage-regulating unit, being coupled to the power receiving device for receiving the second power;
a controlling unit, being coupled to the voltage-regulating unit for controlling the output of the second power; and
a voltage-boosting unit, being coupled to the controlling unit for boosting the voltage value of the second power to a target voltage value;
wherein when the first power source discontinues to supply the first power, the driving mechanism can not continue to operate for driving the garage door to up or down;
wherein after the first power source discontinues to supply the first power, the power receiving device can be electrically connected with the second power source at that time, so that the power receiving device would receive the second power provided by the second power source, and then controlling and boosting device would convert the voltage value of the second power to the target voltage and output the second power for controlling the driving mechanism to operate and drive the garage door to up or down.

2. The electrical garage door with a secondary power supply of claim 1, wherein the first power source is the city electricity.

3. The electrical garage door with a secondary power supply of claim 1, wherein the external second power source is the automobile electricity outputted from a car cigarette lighter socket.

4. The electrical garage door with a secondary power supply of claim 3, wherein the second power source is electrically connected to the power receiving device through a cigarette lighter power cable.

5. The electrical garage door with a secondary power supply of claim 2, wherein the power converting device transmits the second power to the controlling and boosting device through a voltage transmission line.

6. The electrical garage door with a secondary power supply of claim 1, wherein the power receiving device further comprises a water-proof housing.

7. The electrical garage door with a secondary power supply of claim 6, wherein the water-proof housing further having a power socket.

8. The electrical garage door with a secondary power supply of claim 4, wherein the cigarette lighter power cable further has a cigarette lighter plug and a power plug.
